(19) United States
(12) Patent Application Publication
(10) Pub. No.: US 2013/0166300 A1
(43) Pub. Date: Jun. 27, 2013

(54) ELECTRONIC DEVICE, DISPLAYING METHOD, AND PROGRAM COMPUTER-READABLE STORAGE MEDIUM

(71) Applicants: Sachie Yokoyama, Ome-shi (JP); Hideki Tsutsui, Tachikawa-shi (JP)

(72) Inventors: Sachie Yokoyama, Ome-shi (JP); Hideki Tsutsui, Tachikawa-shi (JP)

(73) Assignee: KABUSHIKI KAISHA TOSHIBA, Tokyo (JP)

(21) Appl. No.: 13/612,665

(22) Filed: Sep. 12, 2012

(30) Foreign Application Priority Data
Dec. 27, 2011 (JP) 2011-287007

(51) Int. Cl. G10L 17/00

(52) U.S. Cl. 704/246; 704/E17.003

(57) ABSTRACT

An electronic device includes a voice recognition analyzing module, a manipulation identification module, and a manipulating module. The voice recognition analyzing module is configured to recognize and analyze a voice of a user. The manipulation identification module is configured to, using the analyzed voice, identify an object on a screen and identify a requested manipulation associated with the object. The manipulating module is configured to perform the requested manipulation.

### CROSS REFERENCE TO RELATED APPLICATION(S)

The present disclosure relates to the subject matters contained in Japanese Patent Application No. 2011-287007 filed on Dec. 27, 2011, which is incorporated herein by reference in its entirety.

### FIELD

Embodiments described herein relate generally to an electronic device adapted for processing a web page and using a web browser, a displaying method thereof, and a computer-readable storage medium.

### BACKGROUND

TVs capable of displaying web sites are now being sold on the market. There is a related art in which web browsing can be performed by voice manipulation. For example, there is a type of manipulation where all the elements which can be manipulated on a screen are assigned with numbers to select a target object with the assigned numbers, or there is another type of manipulation by defining a command scheme for utterance to allow the element to be manipulated by the utterance. However, both schemes cannot manipulate contents of the web page through a manipulation of designating a plotting position or a manipulation of the utterance intended by a user.

### BRIEF DESCRIPTION OF THE DRAWINGS

A general configuration that implements the various features of the invention will be described with reference to the drawings. The drawings and the associated descriptions are provided to illustrate embodiments of the invention and should not limit the scope of the invention.

FIG. 1 is a block diagram illustrating an example of the configuration of an electronic device system according to an exemplary embodiment of the present invention;

FIG. 2 is a functional block configuration diagram illustrating main parts according to the embodiment;

FIG. 3 is a flowchart illustrating the operations performed by a manipulation determining module according to the embodiment; and

FIGS. 4A and 4B are images of a user's utterance (input) and a web contents manipulation (output) illustrating an example of the embodiment.

### DETAILED DESCRIPTION OF THE EMBODIMENTS

Hereinafter, one or more exemplary embodiments of the present invention will be described with reference to the accompanying drawings.

According to one embodiment, an electronic device includes a voice recognition analyzing module, a manipulation identification module, and a manipulating module. The voice recognition analyzing module is configured to recognize and analyze a voice of a user. The manipulation identification module is configured to, using the analyzed voice, identify an object on a screen and identify a requested manipulation associated with the object. The manipulating module is configured to perform the requested manipulation.

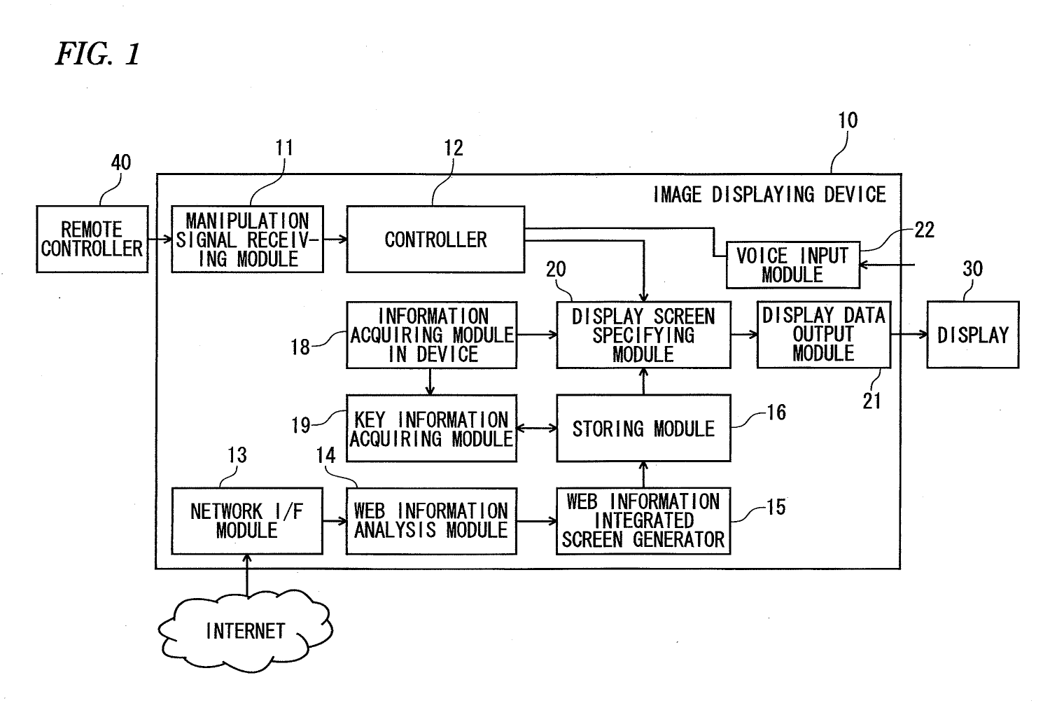

FIG. 1 is a block diagram illustrating the configuration of an electronic device system according to an embodiment of the present invention. The electronic device is implemented with, for example, an image displaying device 10. The electronic device may also be implemented by a personal computer (PC), a tablet PC, a slate PC, a TV receiver, a recording medium for storing image data (for example, a hard disk recorder, a DVD recorder, a settop box), a PDA, a vehicle navigation apparatus, a smart phone, and the like.

The image displaying device 10 includes a manipulation signal receiving module 11, a controller 12, a network OF module 13, a web information analysis module 14, a web information integrated screen generator 15, a storing module 16, an information acquiring module in a device 18, a key information acquiring module 19, a display screen specifying module 20, a display data output module 21, a voice input module 22, and the like.

The manipulation signal receiving module 11 receives a manipulation signal which is transmitted from a remote controller 40 via manipulation of a button by a user to output a signal according to the received manipulation signal to the controller 12. A display instruction button for dictating display of a web information integrated screen is installed on the remote controller 40 and when the display instruction button is manipulated, the remote controller 40 transmits a display instruction signal. When the manipulation signal receiving module 11 receives the display instruction signal, the manipulation signal receiving module 11 transmits a display instruction reception signal to the controller 12. The remote controller 40 may be interactively operated to allow the image displaying device 10 to be operated in a voice input mode, and the mode of image displaying device can be changed by another means.

The network I/F module 13 is communicated with a web site on the Internet to receive web page data. The web information analysis module 14 analyzes the web page data received by the network I/F module 13 to calculate a location of an object such as a text, an image, and the like to be displayed on the display screen.

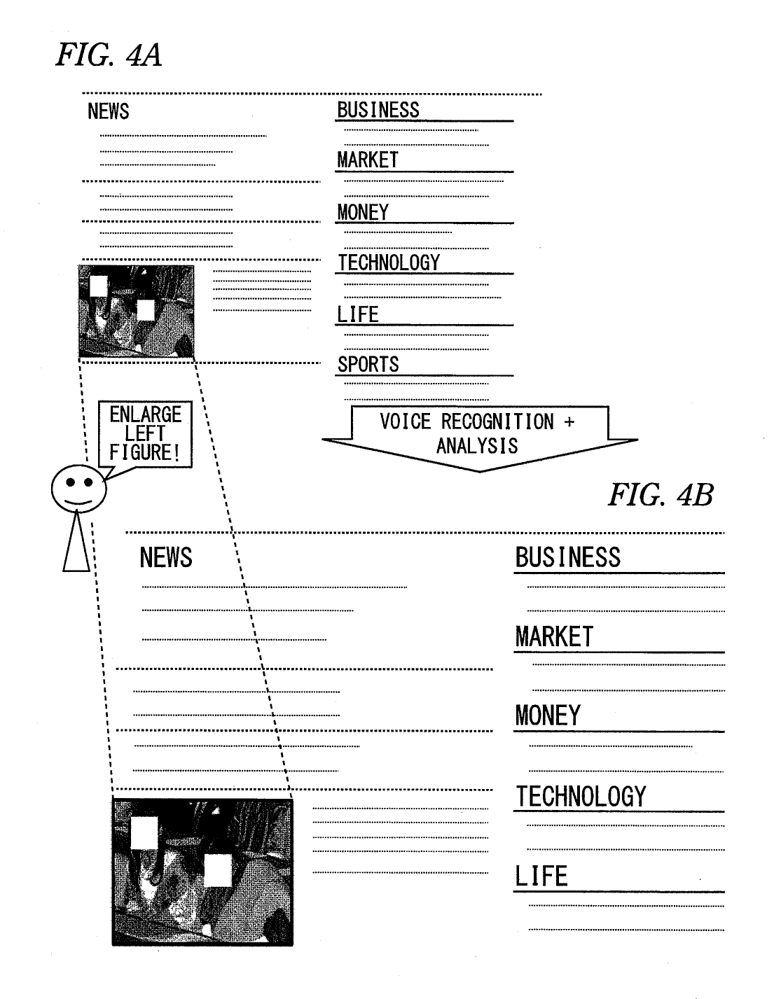

The web information integrated screen generator 15 generates a web information integrated screen on the basis of the analyzed result of the web information analysis module 14 and the manipulation signal based on the manipulation of the remote controller 40. An example of the web information integrated screen displayed on the display screen is shown in FIG. 4. As shown in FIG. 4, objects such as a plurality of texts, images, and the like are disposed in the web information integrated screen.

The web information integrated screen generator 15 stores web information integrated screen data (for example, an address, a location, and the like of the web site) of the generated web information integrated screen in the storing module 16. The storing module 16 may store a plurality of web information integrated screen data. The web information integrated screen data may be generated either from a plurality of web pages or from a single web page. The web page by itself may also be considered as the web information integrated screen.

When the display dictation signal is received from the manipulation signal receiving module 11, the controller 12 transmits a display command for displaying the web information integrated screen to a broadcast data receiving module 17 and the display screen specifying module 20.

The information acquiring module 18 extracts a name of a program (program name) which is being received at present from electronic program guide (EPG) data which is overlapped with the received broadcast data according to reception of the display command and transmits the program name to the display screen specifying module 20.

The key information acquiring module 19 acquires key information from the web information integrated screen data stored in the storing module 16. The key information acquiring module 19 associates the acquired key information with the web information integrated screen data to be stored in the storing module 16. The key information may be, for example, a site name.

When the web information integrated screen data is received, the display data output module 21 instructs the network I/F module 13 to receive the web page based on the web information integrated screen data. The web information analysis module 14 analyzes the web page data received by the network I/F module 13 to calculate a location of an object such as a text, an image, and the like displayed on the display screen. The web information integrated screen generator 15 generates data for displaying the web information integrated screen on which one or more web pages or web clips are disposed, based on the analyzed result of the web information analysis module 14 and the web information integrated screen data. The display data output module 21 generates data to be displayed on the display screen of a display 30 based on the generated data.

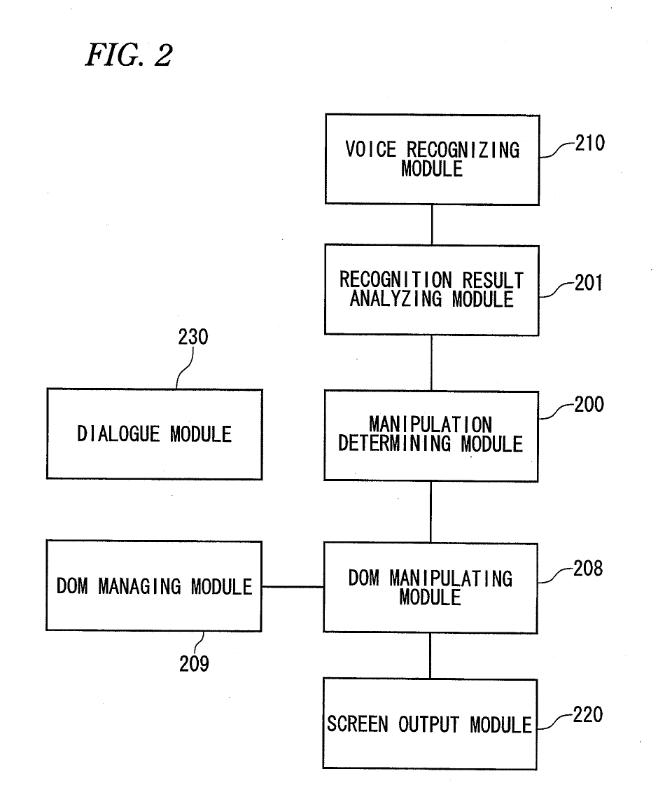

FIG. 2 is a functional block configuration diagram illustrating main modules according to the embodiment of the present invention. The electronic device includes a voice recognizing module 210, a recognition result analyzing module 201, a manipulation determining module 200, a DOM manipulating module 208, a DOM managing module 209, a screen output module 220, and a dialogue module 230.

The voice recognizing module 210 is constituted with a voice input module 22 including a microphone and an amplifier (not shown), a controller 12, and the like. The recognition result analyzing module 201 mainly relies on the controller 12. The manipulation determining module 200 is constituted with a manipulation signal receiving module 11, a controller 12, and the like. The DOM manipulating module 208 mainly relies on the controller 12. The DOM managing module 209 mainly relies on the storing module 16. The screen output module 220 mainly relies on the display data output module 21. The dialogue module 230 relies on the remote controller 40, a manipulation signal receiving module 11, the controller 12, the display data output module 21, and the like.

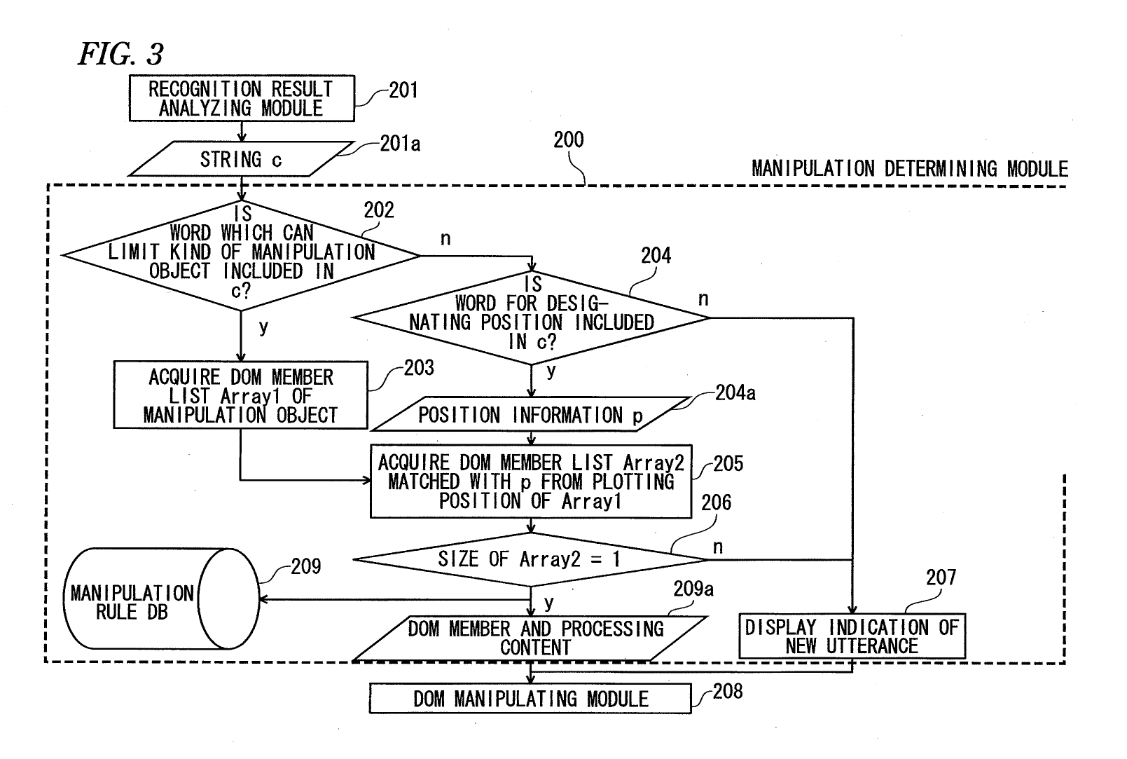

The controller 12 of the voice recognizing module 210 compresses a voice signal, which is input to the voice input module 22 to be amplified or converted from a time domain to a frequency domain using a appropriate scheme, such as, for example, a Fast Fourier Transform (FFT), in the form of text information. The recognition result analyzing module 201 outputs a text string by using the text information. Cooperation of each module based on the manipulation determining module 200 will be described below with reference to a flowchart of FIG. 3.

Herein, a document object model (DOM) and a DOM member will be briefly described. The DOM may indicate a structure in which each element of xml or html, for example, an element referred to as <p> or <img> is accessed. By manipulating the DOM, a value of the element may be directly manipulated. For example, a content text of <p> or a content of src is changed to generate a separate image accordingly. In summary, the document object model (DOM) is an application, a programming, or an Application Programming Interface (API) for an HTML document and an XML document. This is a programming interface specification to define a logical structure of the document or an access to the document or a manipulation method thereof.

With respect to the DOM member and a content for processing, for example, a plurality of processing rules are registered with a manipulation rule DB to be described below.
(L) Link . . . Open URL
(T) Text box . . . Input a string argument
(B) Button . . . Transfer the text string input in the text box to the argument

Meanwhile, FIG. 3 is a flowchart describing a processing of the manipulation determining module 200 which accepts a string c analyzing the recognition result for the user's utterance as an input to output a manipulation content for the DOM member in the web page described with an HTML language, in a voice manipulation browser of the present embodiment.

First, at step 201, it is assumed that one or more words are acquired by morphologically analyzing the voice recognition result.

With respect to the string c (at step 201a) in the analyzed result of the voice recognition, at step 202, it is determined whether a string, which can specify the DOM member which is the object to be manipulated with “input column”, “figure”, “link”, and the like, is included. For example, when the string of the “input column” is included, an object for which a type attribute of an <input> element of the DOM member located in the center of the display page is “textbox” is acquired as an array Array1 at step 203 and then the process proceeds to step 205.

At step 204, it is determined whether words such as “upper”, “lower”, “left”, “right”, “center”, and the like for designating the plotting position are included in the string c. If so, the words for designating the plotting position are set to position information p (at step 204a).

At step 205, an object matched to the position information p is acquired among the object candidates for manipulating of Array1.

At step 206, when the object candidates are narrowed down to one, one object candidate is searched against a separately stored manipulation rule DB (one of the contents of the DOM managing module 209) at step 209. At step 209a, the object DOM member for manipulating and the processing content are outputted and inputted to the DOM manipulating module 208. In the manipulation rule DB, the kinds of object DOM member elements for manipulating and the manipulation content for each element are described. For example, the processing content specified as “Loading a new page with accepting a string of href attribute” for an element <a>, is defined as a manipulation rule.

At steps 204 and 206, when the comparison result is NO, a displaying of dictation utterance of a new user is performed at step 207.

FIGS. 4A and 4B are images of a user's utterances (input) and a web contents manipulation (output) as an example of the embodiment. An image which is plotted at a relatively left side among images in display range of a page is focused and enlarged. This is implemented by allowing the web information analyzing module 14 to function as a rendering engine and allowing the web information integrated screen generator 15 to function as a browser display module. Specifically, the functions of the web information analyzing module 14 and the web information integrated screen generator 15 are performed after voice recognition and analysis for utterance of “Enlarge a left figure!” (transition from a display state of the left figure of FIG. 4A to a display state of the left figure of FIG. 4B).

According to the embodiments described above, when manipulating the browser by using the voice, the information viewed from a user's viewpoint is used to manipulate the link or button included in the web page or the object for manipulating such as the text box and the like, so that a manipulation (for example, web surfing) with natural utterance including information seen to the user can be performed. That is, the embodiment has an effect that the contents of the web page can be manipulated by designating a plotting position or by the utterance intended by the user as dictation. The manipulation by natural utterance may be performed from the user's viewpoint using not only the textual information but also the plotting position used as visual information of the contents as follows.
(1) As a technique for surfing the web using the voice input, rather than an input through a known device such as mouse or keyboard as in the related art, the manipulation by the natural utterance, which is not constrained by a command scheme for utterance, may be performed by specifying the target object using the plotting position on the page which is the information seen to the user.
(2) Since a plurality of pieces of information for restricting the manipulation content during the web surfing may be extracted in a single utterance, the number of manipulation steps may be remarkably reduced as compared with a manipulation in a known device.

The present invention is not limited to the embodiments, but may be variously modified in the range without departing from the scope thereof.

Various embodiments may be formed by appropriately combining a plurality of constitutional elements disclosed in the above-described embodiments. For example, several constitutional elements may be removed from all the constituent elements shown in the embodiments. Alternatively, the constitutional elements relating to another embodiment may be properly combined.

What is claimed is:

1. An electronic device comprising:
a voice, recognition analyzing module configured to recognize and analyze a voice of a user;
a manipulation identification module configured to, using the analyzed voice, identify an object on a screen and identify a requested manipulation associated with the object; and
a manipulating module configured to perform the requested manipulation.

2. The electronic device of claim 1, wherein the manipulating module is configured to perform the requested manipulation based on a document object model.

3. The electronic device of claim 1, further comprising the screen.

4. A displaying method of an electronic device, the method comprising:
recognizing and analyzing a voice of a user;
identifying, using the analyzed voice, an object on a screen and a requested manipulation associated with the object; and
performing the requested manipulation.

5. A computer-readable storage medium storing a program that, when executed, causes a computer to control an electronic device to perform a displaying method comprising:
recognizing and analyzing a voice of a user;
identifying, using the analyzed voice, an object on a screen and a requested manipulation associated with the object; and
generating data for display for performing the requested manipulation.
